(19) United States
(12) Patent Application Publication
(10) Pub. No.: US 2019/0091841 A1
(43) Pub. Date: Mar. 28, 2019

(54) WRENCH WITH PIVOTABLE DRIVING HEAD

(71) Applicant: Yi-Fu Chen, Taichung City (TW)

(72) Inventor: Yi-Fu Chen, Taichung City (TW)

(21) Appl. No.: 15/717,946

(22) Filed: Sep. 28, 2017

(51) Int. Cl. B25B 23/00

(52) U.S. Cl. CPC B25B 23/0028

(57) ABSTRACT

A wrench includes a handle with a recess that opens through a periphery and an end face of the handle. An extension unit is pivotably connected to the recess by a pivot. The extension unit includes two bars and each bar has a clamp portion and an insertion portion. The insertion portion is pivotably connected to the recess by the pivot, and the clamp portions are pivotably connected to a driving head therebetween. The extension unit is pivotable relative to the handle so that the wrench is used in different ways.

### BACKGROUND OF THE. INVENTION

### 1. Fields of the Invention

The present invention relates to a wrench, and more particularly, to a wrench with a pivotable driving head.

### 2. Descriptions of Related Art

The conventional wrench with a pivotable driving head known to applicant is disclosed in FIG. 6, and comprises a handle 40 which includes two arms 41 extending from one end thereof. Each of the two arms 41 has a pivotable hole 42. A driving head 50 includes a driving part 51 extending axially from one side thereof, and two protrusions 52 extending diametrically from outside thereof. The two protrusions 52 are pivotably engaged with the two pivotal holes 42 of the two arms 41 so that the driving head 50 is pivotable relative to the two arms 41. A slot 43 defined in the handle 40 and communicates with the space embraced by the two arms 41. The slot 43 allows the two arms 41 to be slightly expanded outward so as to remove/engage the two protrusions 52 from/with the two pivotal holes 42 of the two arms 41 so that the driving head 50 is installed to or removed from the two arms 41.

Although the driving head 50 can be pivoted to a desired angle to drive an object by the driving part 51, the driving head 50 is the only replaceable part to be connected with the handle 40.

The handle 40 is made by way of forging to have better strength, and the slot 43 is then cut in the handle 40. The manufacturing processes and cost are too high for a wrench.

The present invention intends to provide a wrench with a pivotable driving head, and the present invention eliminates the shortcomings mentioned above.

### SUMMARY OF THE INVENTION

The present invention relates to a wrench and comprises a handle having a grip and a connection portion on two ends thereof which are located along an X-axis of the handle. The connection portion has a recess defined along the X-axis, and the recess includes an opening and an inner bottom in a Z-axis of the handle. The opening is defined through the periphery and an end face of the connection portion. A pivot extends along a Y-axis of the handle and through the recess in the connection portion. A circular driving head has a driving part extending axially from one side of the driving head. Two protrusions extend diametrically from outside of the driving head.

An extension unit includes two bars, and each bar includes a clamp portion and an insertion portion on two ends thereof. A groove defined axially in one side of each of the two bars for reinforcement of the bars. The groove communicates with the clamp portion and the insertion portion. The clamp portion is bent relative to the insertion portion of each bar and has a first pivotal hole. The two protrusions of the driving head are pivotably engaged with the two first pivotal holes of the two bars. Each insertion portion has a second pivotal hole, and two rivet holes are defined between the first and second pivotal holes of each bar. Two rivets rivet the two bars by the two rivet holes of each bar. The insertion portion of each bar is inserted in the recess, and the pivot extends through the two respective second pivotal holes so that the two bars are pivotable about the pivot. When the two bars are pivoted to be perpendicular to the handle, the insertion portions extend through the opening and contact the inner bottom.

Preferably, the first pivotal hole is defined through the inner end of the groove and communicates with the groove of each bar.

Preferably, the second pivotal hole and the rivet holes are defined through the inner end of the groove and communicate with the groove of each bar.

Preferably, the driving part of the driving head is a rectangular part, and the two protrusions are integrally formed with the driving head.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is an exploded view of the wrench of the present invention;

FIG. 3 is a cross sectional view, taken along line III-III in FIG. 1;

FIG. 4 shows that the extension unit is pivoted to be perpendicular to the handle;

FIG. 5 is perspective view to show that the extension unit is pivoted to be perpendicular to the handle, and

FIG. 6 is an exploded view of the conventional wrench.

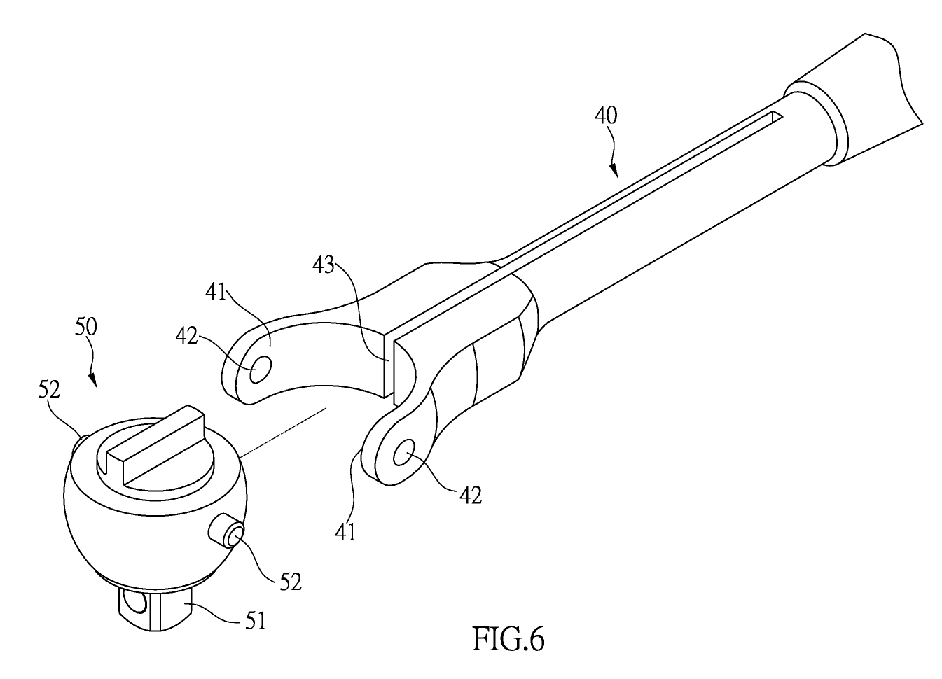

### DETAILED DESCRIPTION OF THE PREFERRED EMBODIMENT

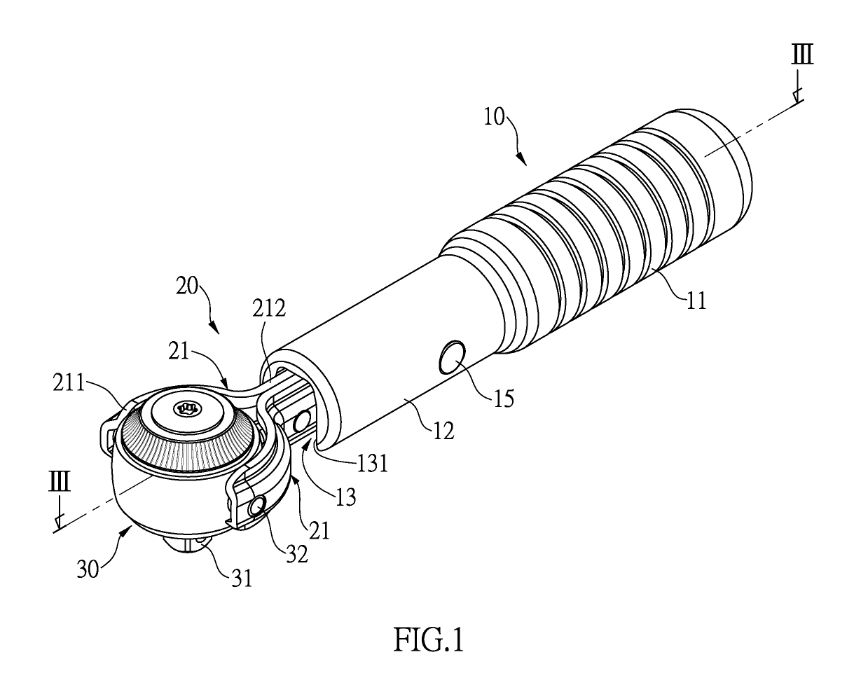

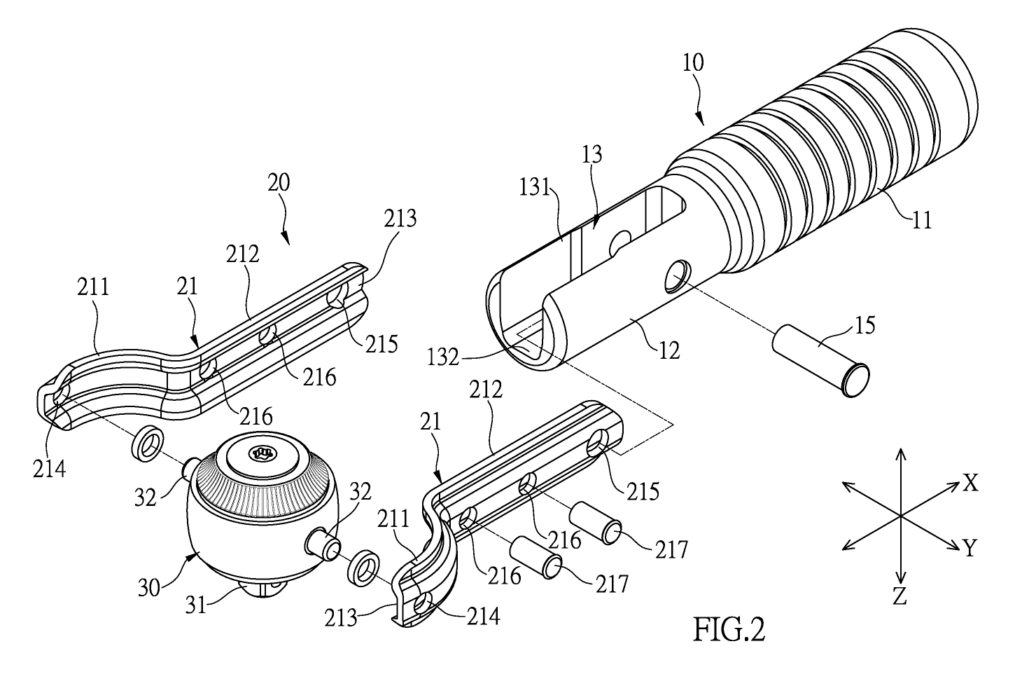

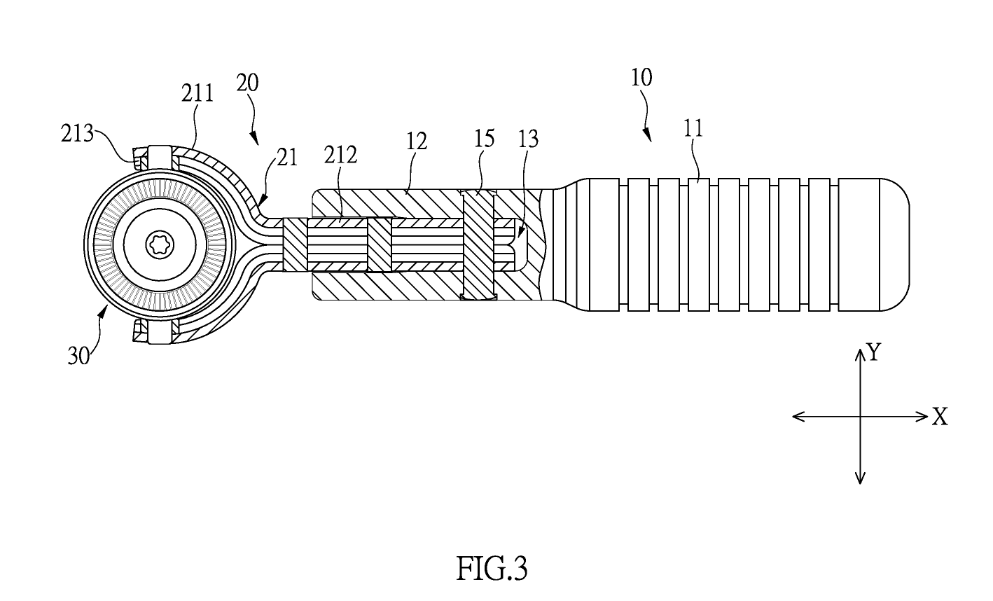

Referring to FIGS. 1 to 3, the wrench of the present invention comprises a handle 10 which defines an X-axis, a Y-axis and a Z-axis. A grip 11 and a connection portion 12 are located on two ends thereof which are located along the X-axis of the handle 10. The connection portion 12 has a recess 13 defined along the X-axis, and the recess 13 includes an opening 131 and an inner bottom 132 in the Z-axis of the handle 10. That is to say, the opening 131 is defined through the periphery and an end face of the connection portion 12. A pivot 15 extends along the Y-axis of the handle 10 and through two walls of the recess 13 in the connection portion 12.

A circular driving head 30 has a driving part 31 extending axially from one side of the driving head 30. Two protrusions 31 extend diametrically from outside of the driving head 30. In this embodiment, the driving part. 31 of the driving head 30 is a rectangular part, and the two protrusions 32 are integrally formed with the driving head 30.

An extension unit 20 includes two bars 21, and each bar 21 includes a clamp portion 211 and an insertion portion 212 on two ends thereof. A groove 213 is defined axially in one side of each of the two bars 21 so as to reinforce the structural strength of the bars 21. The groove 213 communicates with the clamp portion 211 and the insertion portion 212.

The clamp portion 211 is bent relative to the insertion portion of each bar 21 and has a first pivotal hole 214. The first pivotal hole 214 defined through the inner end of the groove 213 and communicates with the groove 213 of each bar 21. The two protrusions 32 of the driving head 30 are pivotably engaged with the two first pivotal holes 214 of the two bars 21. Each insertion portion 212 has a second pivotal hole 215, and two rivet holes 216 are defined between the first and second pivotal holes 214, 2.15 of each bar 21. The second pivotal hole 215 and the rivet holes 216 are defined through the inner end of the groove 213 and communicate with the groove 213 of each bar 21. Two rivets 217 rivet the two bars 21 by the two rivet holes 216 of each bar 21. The insertion portion 212 of each bar 21 is inserted in the recess 13, and the pivot 15 extends through the two respective second pivotal holes 215 so that the two bars 21 are pivotable about the pivot 15.

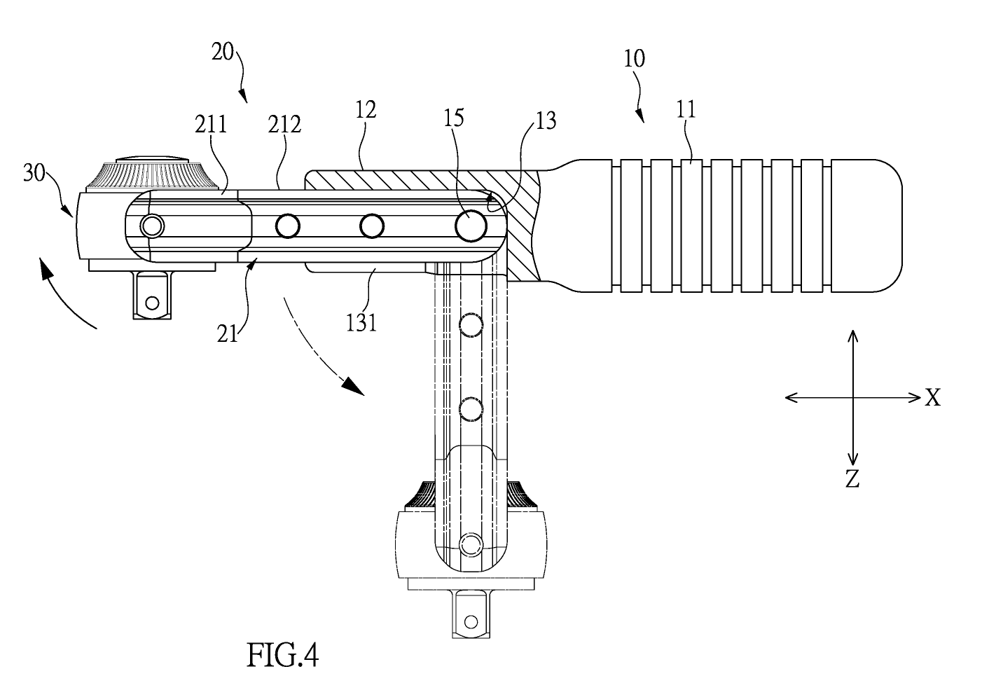

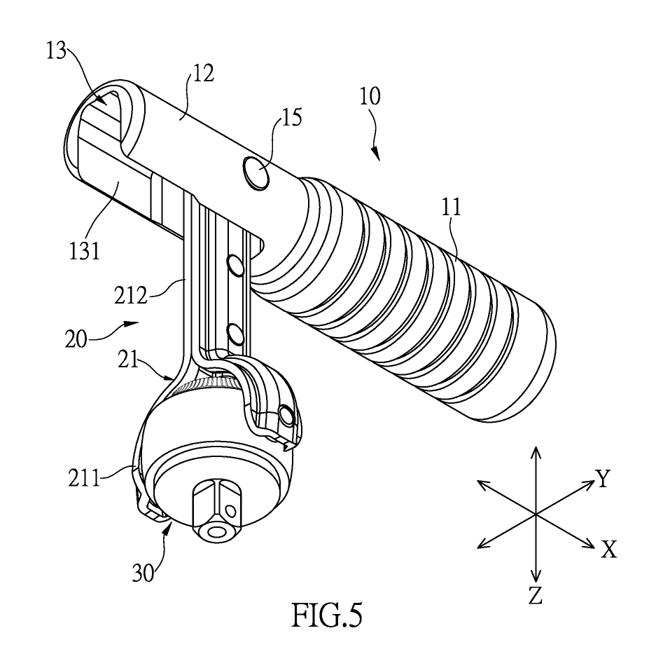

As shown in FIGS. 4 and 5, when the two bars 21 are pivoted to be perpendicular to the handle 10, the insertion portions 212 extend through the opening 212 and contact the inner bottom 132. The insertion portions 212 contact against the two walls of the recess 13 in the Y-axis direction so as to provide a stable and reliable operation to the wrench. The users may holed the two ends of the handle 10 to operate the driving head 30 when the two bars 21 are pivoted and positioned to be perpendicular to the handle 10.

The wrench provides multiple ways of operation by pivoting the extension unit 20 relative to the handle 10.

Each bar 21 includes a groove 213 which is made by way of pressing so as to have better strength. The groove 213 can be quickly made in each bar to save manufacturing cost.

While we have shown and described the embodiment in accordance with the present invention, it should be clear to those skilled in the art that further embodiments may be made without departing from the scope of the present invention.

What is claimed is:

1. A wrench comprising:
a handle having a grip and a connection portion on two ends thereof which are located along an X-axis of the handle, the connection portion having a recess defined along the X-axis, and the recess including an opening and an inner bottom in a Z-axis of the handle, the opening defined through a periphery and an end face of the connection portion, a pivot extending along a Y-axis of the handle and through the recess in the connection portion;
a circular driving head having a driving part extending axially from one side of the driving head, two protrusions extending diametrically from outside of the driving head, and
an extension unit having two bars, each bar including a clamp portion and an insertion portion on two ends thereof, a groove defined axially in one side of each of the two bars for reinforcement of the bars, the groove communicating with the clamp portion and the insertion portion, the clamp portion being bent relative to the insertion portion of each bar and having a first pivotal hole, the two protrusions of the driving head pivotably engaged with the two first pivotal holes of the two bars, each insertion portion having a second pivotal hole, two rivet holes defined between the first and second pivotal holes of each bar, two rivets riveting the two bars by the two rivet holes of each bar, the insertion portion of each bar inserted in the recess and the pivot extending through the two respective second pivotal holes so that the two bars are pivotable about the pivot, when the two bars are pivoted to be perpendicular to the handle, the insertion portions extending through the opening and contact the inner bottom.

2. The wrench as claimed in claim 1, wherein the first pivotal hole is defined through an inner end of the groove and communicates with the groove of each bar.

3. The wrench as claimed in claim 1, wherein the second pivotal hole and the rivet holes are defined through an inner end of the groove and communicate with the groove of each bar.

4. The wrench as claimed in claim 1, wherein the driving part of the driving head is a rectangular part, the two protrusions are integrally formed with the driving head.
